(19) United States
(12) Patent Application Publication
(10) Pub. No.: US 2024/0348728 A1
(43) Pub. Date: Oct. 17, 2024

(54) SELECTIVE CONTROL OF AUDIO IN VIRTUAL CONFERENCE ROOMS

(71) Applicant: Bounce Conferencing LLC, Denver, CO (US)

(72) Inventor: Elijah Parkhurst, Denver, CO (US)

(21) Appl. No.: 18/633,211

(22) Filed: Apr. 11, 2024

Related U.S. Application Data
(60) Provisional application No. 63/458,511, filed on Apr. 11, 2023.
(60) Provisional application No. 63/538,448, filed on Sep. 14, 2023.

(51) Int. Cl. H04M 3/56; H04L 65/1089; H04L 65/1093; H04L 65/1096; H04L 65/401

(52) U.S. Cl. CPC H04M 3/568; H04L 65/1089; H04L 65/1093; H04L 65/1096; H04L 65/4015; H04M 3/567

(57) ABSTRACT

Computer methods and systems allow for selective control of the audio and visual output of users in a virtual conference room. For example, users may be grouped into groups, and users within a group may see and hear other users within that group more prominently than users outside the group. Groups may be associated with other groups as peripheral, and users in a group associated as peripheral may see and hear other users in the peripheral group less prominently. Additionally, a user may be designated as a main speaker, and all users may see and hear that main speaker more prominently than other users in the virtual conference room. Further, a user may direct audio input to one or more users through a whisper. AI may be used to improve the system.

### CLAIM OF PRIORITY

This application claims priority to and the benefit of U.S. Provisional Application No. 63/458,511, filed Apr. 11, 2023, and U.S. Provisional Application No. 63/538,448, filed Sep. 14, 2023, the disclosures of which are hereby incorporated by reference herein in their entirety.

### INTRODUCTION

Video conferencing has increasingly become an integral part of doing business. With the introduction of high-definition audio, users can now experience crystal-clear sound quality. In addition, most audio-conferencing systems have features such as call recording, virtual backgrounds, and mute options. Many audio-conferencing systems also integrate with other applications, such as instant messaging, file sharing, and screen sharing, making collaboration and communication more efficient.

One issue with the current state of video conferencing, however, is that participants who are in the same virtual “room” hear and see everyone equally, regardless of their “virtual” proximity or level of involvement in the conversation. This differs from the real-life experience of being in a physical room, where certain people's voices and appearances are more prominent while others are at the periphery.

The problems that arise in video conferencing can be frustrating and distracting for participants, ultimately leading to negative impacts on the overall flow of the conversation. For example, when participants talk over each other, it can be difficult for other participants to follow the conversation and make sense of what is being discussed. This can lead to misunderstandings, confusion, and missed opportunities to contribute to the conversation.

Similarly, when participants cannot hear each other clearly, it can be challenging to maintain engagement and focus. Participants may become distracted or disengaged, leading to a decrease in productivity and collaboration. Additionally, participants who are not heard clearly may feel left out of the conversation or undervalued, which can negatively impact morale and motivation.

In a virtual conference environment, using network bandwidth and computing processing power to render unwanted videos and broadcast unwanted audio further exacerbates this problem. For example, slower network connectivity and clunky computer experiences may result.

These issues are particularly important in contexts where effective communication is crucial, such as in business meetings, classrooms, or healthcare settings. As a result, addressing the challenges of video conferencing is an ongoing priority for the industry, and there is an ongoing need for innovation and technological advancements to ensure that virtual communication remains effective and efficient. It is with respect to these and other considerations that the technologies described below have been developed. Also, although relatively specific problems have been discussed, it should be understood that the examples provided are not meant to be limited to solving the specific problems identified in the introduction or elsewhere.

### SUMMARY

Aspects of the technology include a computer-implemented method. The method includes receiving a plurality of requests to join a virtual meeting. The method also includes allowing access to the virtual meeting to at least a first user, a second user, a third user, and a fourth user based in part on in part the plurality of requests. The method also includes grouping the first user's audio input and the second user's audio input into a first audio input cluster. The method also includes grouping the third user's audio input and the fourth user's audio input into a second audio input group. The method also includes altering a first-user audio output to the first user such that the first audio group is louder than the second audio input group.

In aspects, the method also includes outputting instructions to the first user to display a visual representation of a second user more prominently than a visual representation of the third user or a visual representation of a fourth user. The method may also include receiving, from a whispering user, a request to private message a target user of a virtual conference call. The method may also include sending a request to accept the private message to a client application associated with the target user, receiving an indication of acceptance, and, based on receiving the indication of acceptance, setting a whispering environment to facilitate a private voice conversation between the target user and the whispering user. Setting the whispering environment may alert other members a group associated with the target user that the target user is in a private conversation. Alerting may include changing a video image of the target user to a still image. The method may also include associating a first user's input with the first user, analyzing, using a Deep Neural Network, the first user's input to determine the first user's topic of conversation, and suggesting a different group to the first user based on the determination. The method may also include receiving an indication that the first user wishes to change groups based on the suggesting operation.

Additionally/alternatively, aspects of the technology include a computer-implemented method. The method includes receiving, by a server, a request from a plurality of clients to join a virtual conference call. In some aspects, the plurality of clients includes a first client having a first input communication stream including audio and video data captured by the first client and a second client having a second input communication stream including audio and video data captured by the second client. The method also includes sending at least a portion of the audio and video data captured by the first client and at least a portion of the audio and video data captured by the second client to at least a portion of the other of the plurality of clients. The method also includes receiving a request from the first client to send a private whisper to the second client. The method also includes setting a whisper environment based on the request.

Setting the whisper environment may include reducing the amount of data of the audio and video data captured by the first client that is sent to the at least a portion of the other of the plurality of clients. Setting the whisper environment may also include reducing the amount of data of the audio and video data captured by the second client that is sent to the at least a portion of the other of the plurality of clients. The method may also include sending an indication to the at least a portion of plurality of other clients that the first client and the second client are in a whisper environment. The indication may be selected from the group consisting of: graphical indication, changing the video feed of the first client and the second client to a still image, and an audio indication. The method may also include before setting the whisper environment, sending an approval request to the second client and receiving, from the second client, an approval.

The computer-implemented methods may be stored on a computer-readable storage device that stores instructions that, when executed, perform the method.

### BRIEF DESCRIPTION OF THE DRAWINGS

FIG. 1 illustrates a networked-computing environment for facilitating a virtual conference call.

FIG. 2 is an example system that provides selective control of audio and video streams in a virtual environment.

FIGS. 3A and 3B illustrate an example of handling a change in user group assignment.

FIGS. 4A and 4B are tables that illustrate handling changes to primary and peripheral communication streams based on changing group assignments.

FIG. 5 is an example method for assigning a user of a virtual call to a group.

FIG. 6 is an example method of organizing input communication streams for users of a virtual call.

FIG. 7 is an example method for determining content delivery to users of a group.

FIG. 8 is an example method for determining peripheral content to deliver to users of a particular group.

FIG. 9 is a method for analyzing a virtual call using artificial intelligence.

FIG. 10 is a method for training a DNN using feedback from a virtual call.

FIG. 11 is an example diagram of a distributed system in which aspects of the present technology may be practiced.

FIGS. 12A and 12B are example embodiments of the architecture of a system for facilitating a conference call.

FIG. 13 illustrates one aspect in which an exemplary architecture of a computing device can be used to implement aspects of the present disclosure.

FIG. 14 is a block diagram illustrating additional physical components (e.g., hardware) of a computing device.

### SELECTIVE CONTROL OF AUDIO IN VIRTUAL CONFERENCE ROOMS

Aspects of the technology relate to video conferencing. In aspects, the technology provides a server the ability to selectively choose which members of a virtual conference room are focused, which are in the peripheral, and which are not displayed. In aspects of the technology, one or more servers adjusts the audio and visual prominence of participants in the conference room to highlight certain participants while reducing the volume and visual prominence of others. In examples, a user chooses a group to join. In examples, the members of that group are displayed more prominently to other ingroup members. Other members of the virtual conference may be displayed/heard less prominently (e.g., members or users who are in the peripheral groups to the group the user is in). Some participants of the conference call may not be displayed at all to a particular user.

For some applications, this technology allows users to have more control over their virtual communication environment, making it easier to follow conversations and stay engaged with other participants. For example, users can choose to focus on the speaker or speakers who are most relevant to the topic being discussed while minimizing distractions from other participants who may be less involved in the conversation of interest to the user.

One possible application of this technology is in educational settings, where instructors can use this feature to ensure that all students are able to hear and engage with the material being presented. By selectively highlighting certain students and reducing the volume of others, instructors can help minimize distractions and ensure that everyone is able to stay focused on the topic at hand. For example, the teacher may group students into groups, which will allow the students to hear other students within the group more prominently than others in the virtual classroom. The other group of students, however, may still be heard by outside-clustered students, though less prominently, thus replicating the experience of a classroom.

Overall, this technology represents a significant step forward in the field of video conferencing, providing users with more control over their virtual communication environment and helping to improve the overall effectiveness and efficiency of virtual communication. Moreover, using the technology, the server can save bandwidth by sending only information sufficient to display/broadcast users who are prominently displayed or displayed in the peripheral, and not necessarily all members of the conference call.

In particular, aspects of the technology relate to a computer method that may be used to selectively control audio and visual displays in a virtual conference room. The technology includes a method that groups members of a video conference into groups based on user selection. For example, a user may interact with a GUI to join a group of other members of the conference room. In other examples, a user with administrative capabilities (e.g., a teacher) may group other members into a group. In some examples, the user may opt to leave that group and join another group.

In additional aspects of the technology, a user may invite another member of the virtual conference room to the user's current group (or other group). Additionally, one user may whisper to another user. A whisper, in examples, is a directed audio and/or video (real-time or not) message to another user. The message may not be heard by certain members (e.g., one or more members in a group or all other members of the virtual conference call).

In examples, once the participants have been grouped, the method reduces the volume and visual appearance of all other members/other groups of the virtual conference room who are not a part of the group. In some applications, this helps to minimize distractions and ensure that participants can focus on the relevant parts of the conversation without being overwhelmed by extraneous audio and visual stimuli. Additionally, this may help in limiting network usage and computer processing usage by limiting the information sent to user devices (e.g., participant computers running client applications to facilitate the virtual conference call).

In additional examples, a computer method that can be used to selectively control audio in a virtual conference room involves giving priority to a main speaker by one or more users to be more prominent than all other members of the conference room. This method may, in examples, create an experience of a main speaker(s) being on stage and the other members being in a crowd, with the main speaker being the focus of attention. Once the main speaker(s) has been identified (e.g., through a user interface), the method increases the main speaker's audio volume and visual appearance, in examples, while decreasing the volume and visual appearance of all other members of the conference room (for each user, for example).

This approach helps to ensure that the main speaker is heard clearly and that their message is conveyed effectively, while still allowing other participants to be heard and seen to a lesser extent. It also helps to create a more natural and dynamic conversation flow, similar to what one might experience in a physical meeting room.

The technology can be customized to suit the specific needs of different users and contexts and can be implemented using a variety of software tools and platforms. For example, it can be used in business meetings or educational settings to ensure that the main speaker is able to deliver their message effectively or in large virtual events such as webinars or conferences where there is a need to prioritize certain speakers.

Overall, this technology represents an innovative and effective approach to selectively controlling audio in virtual conference rooms, helping to improve the quality and efficiency of virtual communication. For some applications, these improvements come along with the added benefit of reducing network bandwidth usage and computer processing resources for both server and participant computers.

These and various other features as well as advantages that characterize the systems and methods described herein, will be apparent from a reading of the following detailed description and a review of the associated drawings. Additional features are set forth in the description, which follows and, in part, will be apparent from the description or may be learned by practice with the technology. The benefits and features of the technology will be realized and attained by the structure, particularly pointed out in the written description and claims hereof, as well as the appended drawings.

It is to be understood that both the foregoing introduction and the following detailed description are exemplary and explanatory and are intended to provide further explanation of the innovative technologies as claimed and should not be taken as limiting.

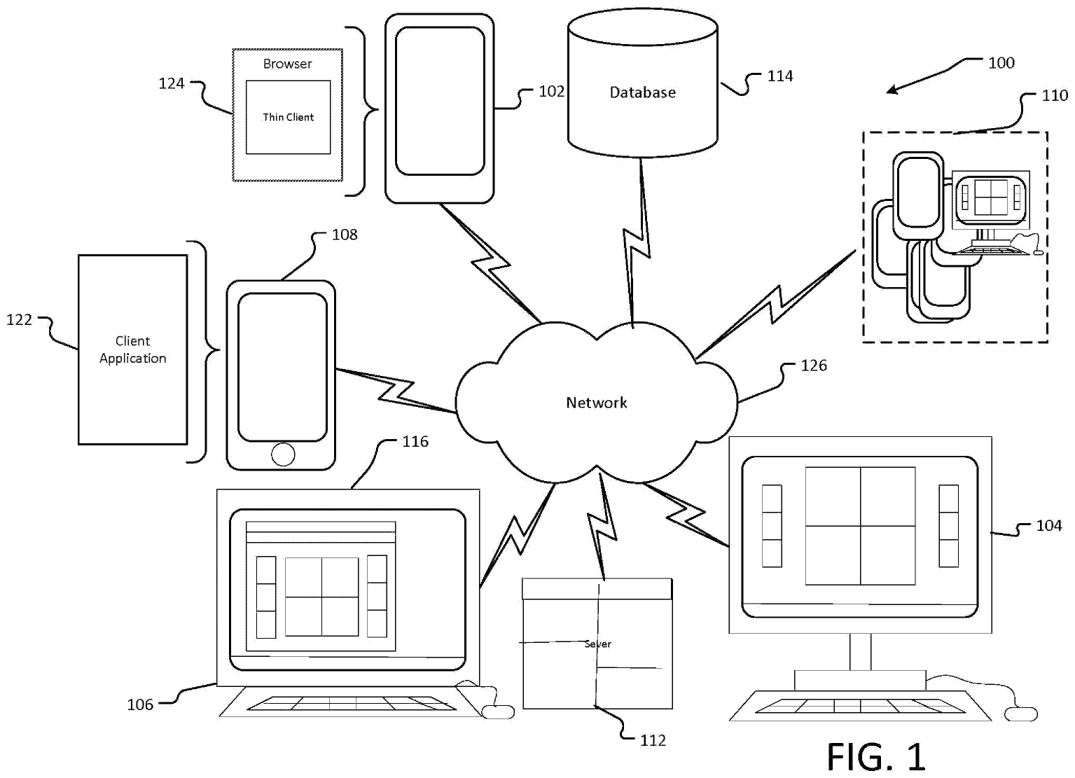

FIG. 1 illustrates a networked-computing environment 100 for facilitating a virtual conference call in which various technologies described herein may be employed. As illustrated, FIG. 1 includes a first participant computing device 102, a second participant computing device 104, a third participant computing device 106, a fourth participant computing device 108, a plurality of other participant computing devices 110, a server 112, and a database 114, each of which is communicatively coupled to each other via a network 126.

Participant computing devices may be any suitable type of computing device. For example, the computing device may be a desktop computer, a laptop, a computer, a tablet, a mobile telephone, a smartphone, a wearable computing device, or the like. The first participant computing device 102 is illustrated as a smartphone, the second participant computing device 104 is illustrated as a desktop computer, the third participant computing device 106 is illustrated as a laptop computer, and the fourth participant computing device 108 is illustrated as a tablet. The plurality of other particpant computing devices 110 may be any computer device. It will be appreciated that more or less computing devices may be present in a networked environment without deviating from the scope of the innovative technologies described herein.

In examples, participant computing devices have one or more executable programs or applications capable of interacting with one or more servers, such as server 112, to allow a user of a participant computing device to participate in a video conference. For example, FIG. 1 illustrates a first client application 122 that is running on the fourth participant computing device 108. The first client application 122 may be a downloadable application that is configured to run on the operating system of the fourth participant computing device 108 and allow a user to participate in a conference call. One skilled in the art will appreciate that other means of participating in the virtual conference call are contemplated, such as the use of a browser 124 operating on a first participant computing device 102.

Participating with the virtual conference call is facilitated by, in examples, one or more servers. For example, one or more servers, such as server 112, handles media relaying and processing. As an example, the server 112 may receive various audio and video streams from the participant devices, such as the first participant computing device 102, the second participant computing device 104, the third participant computing device 106, the fourth participant computing device 108, and a plurality of other participant computing devices 110. The server 112 may then send various output streams of video/audio to the computing devices to cause the audio and/or video of certain conference call attendees to be more prominent as further described herein. In examples, the server 112 may handle audio and video streams using a variety of techniques, including mixing.

As illustrated, one or more servers, such as a server 112, may perform a variety of other functions related to the conference call session. These functions include, but are not limited to, managing call initiation and termination for various participants, managing user authentication, stabilizing connections (e.g., such as by managing latency, jitter, and packet loss), terminating the call session, providing real-time transcription, noise suppression, and/or echo cancellation, synchronizing shared content such as screen sharing, presentations, and/or collaborative documents, maintaining the order of messages in a chat or instant messaging, recording and storage of conference call, and/or security and encryption. The server 112 may also perform other functions such as billing and usage reporting, tracking call metrics, and providing API integration capabilities for third-party applications, CRMs, calendaring, or other enterprise software.

A networked database 114 is illustrated. In aspects, the networked database 114 stores information such that the information is accessible over the network 126 by various devices, including the first participant computing device 102, the second participant computing device 104, a third participant computing device 106, the fourth participant computing device 108, a plurality of other participant computing devices 110, a server 112, be it through a local area network (LAN) or the internet, or other suitable network connection.

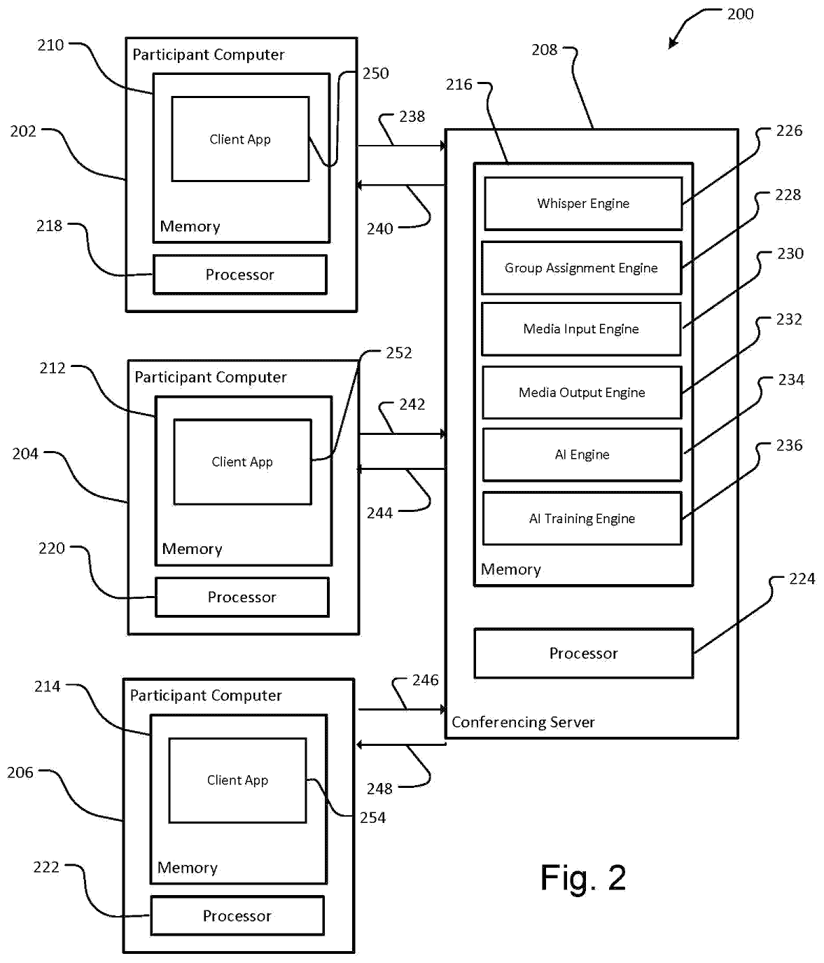

FIG. 2 is an example system 200 to provide selective control of audio and video streams in a virtual environment. As illustrated, the server 208 stores various engines in server memory 216, including a whisper engine 226, a group assignment engine 228, a media input engine 230, a media output engine 232, an AI engine 234, and an AI training engine 236. The server memory 216 is in electronic communication with processor 224. While illustrated as a single computer with a processor 224, it will be appreciated that multiple servers and/or multiple processors may be implemented without deviating from the scope of the innovative technologies described herein.

In examples, the group assignment engine 228 assigns the clients running on each participant computer to one or more groups during a virtual conference call. In an example, a user interacts (through a touch screen or other input device) with the client application of a participant computer to select or otherwise indicate that the user wishes to be assigned to a group comprising other users in the virtual conference call. In examples, the group assignment engine 228 receives that input and assigns the participant computer to the group indicated by the user interaction. In some examples, a user may be defaulted to no group or a predetermined group. Group assignments may be used to determine the prominence of audio/video displayed/broadcast of other user(s) in the conference call.

In some examples, a group assignment engine 228 assigns users to groups and handles change requests as follows. The group assignment engine 228 may receive input from a client application, such as first client application 250, second client application 252, or third client application 254, indicating that the user of the client application wishes to join a group of the virtual conference. The group assignment engine 228 then, in an example, associates that user with the group.

Group assignment engine 228 may also assign peripheral groups to other groups. One scheme for determining peripheral groups vis-a-vis other groups is a two-peripheral linear scheme. Such linear scheme may work as follows: when a first group is formed, that first group has no peripheral groups. When a second group is formed, the second group is peripheral to the first group and the first group is peripheral to the second group. When a third group is formed, that third group is peripheral to the first and second group. The second group will now be peripheral to the third group and the first group. The first group will be peripheral to the second and fist group. Thereafter, if another group is formed, that group will be added to the end, the previously last group will sever its peripheral connections to the first group and instead connect with the newly joined group, and the newly formed group will associate the first group as peripheral. Thus, the topography of a 6-group conference call, may look like:

where nodes that are connected by lines indicate a group being associated as peripheral to the connected group(s). If a new group, group 7 is formed, then the topography may then change to:

In the example illustrated, the server 208 is in electronic communication with a first participant computer 202, a second participant computer 204, and a third participant computer 206. In this example, the conferencing server receives input from the first participant computer 202 via a first input communications channel 238, receives input from a second participant computer 204 from a second input communications channel 242, and receives input from a third participant computer 206 via a third input communications channel 246.

Input communications channels, such as a first input communications channel 238, includes information transmitted from participant computers. For example, audio information and visual information may be captured at various participant computers (e.g., via a microphone and/or camera in electronic communication with the participant computers), processed, and sent via the communications channel (through, for example, a network, such as the Internet) to the server 208.

In an aspect of the technology, the media input engine 230 receives the various input communications channels and processes the input. For example, the audio and video input received from the various participant computers may be identified and associated with users and groups by the media input engine 230.

In examples, a whisper engine 226 handles private messages from one user to another user in a virtual meeting. For example, a user may interact with a client application, such as a first client application 250 via a GUI, and cause a private message to be sent to another user, such as a second user on a second participant computer 204 interacting with a second client application 252. In examples, the whisper engine 226 receives the indication that the first user wishes to whisper to the second user and handles the request. For example, the whisper engine may direct some or all information contained in first input communication channel 238 (e.g., audio and video content) to be directed only to the second participant computer 204 via the second output communication channel 244. The whisper engine 226 may also send information to other client applications that are not a part of the private communication, such as third client application 254 operating on the third participant computer 206. This information may be an indication that the two users are in private communication.

A media output engine 232 handles sending the appropriate output to various users in a virtual call setting based on group affiliation. In an example, the media output engine 232 may cause audio output and/or video output to be delivered and adjusted to users based on that user's association with a group. For example, a client application associated with a user may receive information to cause virtual call participants of that same group to be more prominently displayed/broadcast than other participants of a conference call. As another example, a client application may broadcast audio/video input of users who are in periphery groups less prominently than the audio/video of others in a group of users. Audio/video of users in groups that are not associated with a user group may not be sent to the user at all.

Also illustrated is an AI engine 234 and an AI training engine 236. In aspects of the technology, the AI engine 234 analyzes the natural language of the group and performs numerous functions based on the analysis. For example, the AI engine 234 may change the heading of the group name to match the topic of conversation and may suggest users to join another group. The AI engine 234 may also suggest users form a sub or different group. Each of these suggestions is, in examples, based on an analysis performed by the AI engine 234 of the words exchanged in the virtual conference room by the various users. In examples, the AI training engine 236 may adapt the AI engine 234 by monitoring whether the users positively/negatively react to the changes/suggestions of AI engine 234. For example, where the users click accept or do not revert the group name to another and/or previous group name, the AI training engine 236 may register that as a positive, tag the content used to generate the suggestion, and use that information to train the AI engine 234.

Groups may also be associated with one another, such as a group being in the periphery of another group. Following this example, when a first group associates with a second group as peripheral, a user in the first group may be able to interact with users of the second group in a different manner than other users not in the peripheral use. In an example, the first group members may be able to see the second group members on a smaller portion of their screen, whisper to the second group members, join the second group, etc. A more fulsome explanation of group interactions is provided with reference to the figures below.

In the example illustrated, the first participant computer 202 has a first memory 210 operating a first client application 250 using a processor 218, the second participant computer 204 has a second memory 212 operating a second client application 252 using a processor 220, and a third participant computer 206 has a third memory 214 operating a third client application 254 using a processor 222. It will be appreciated that client applications may be run using multiple processors across distributed systems as further described herein.

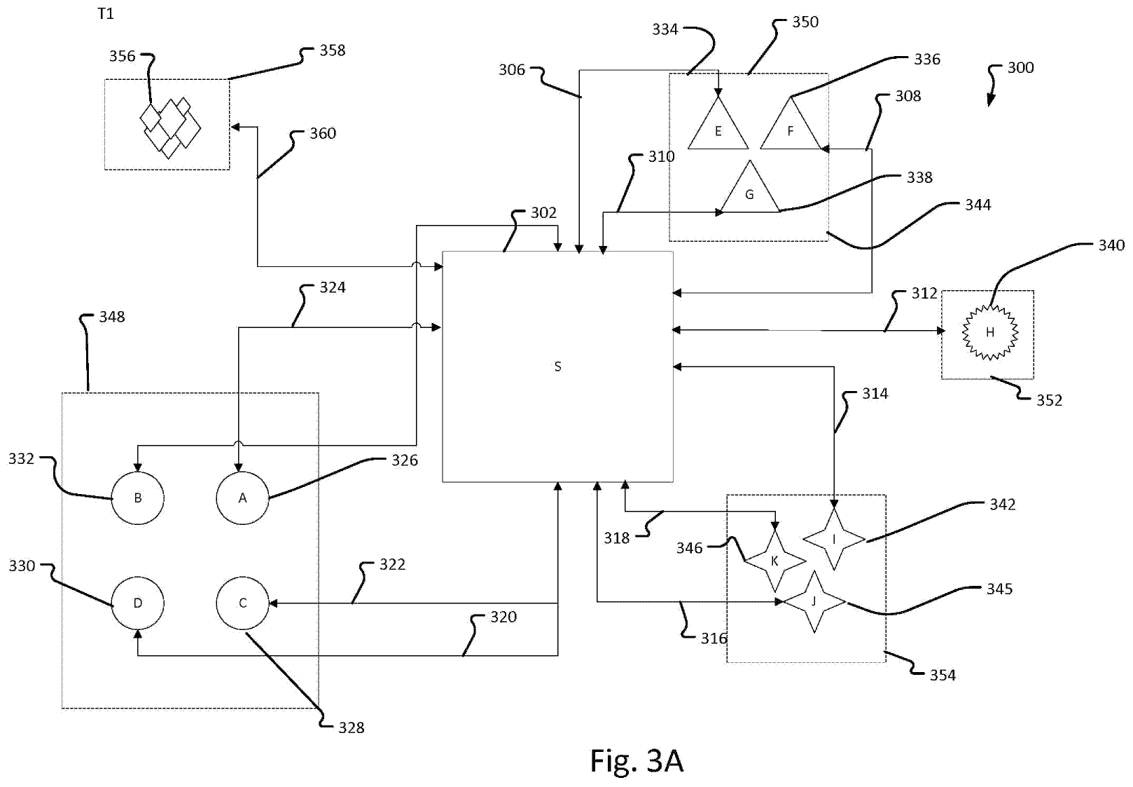

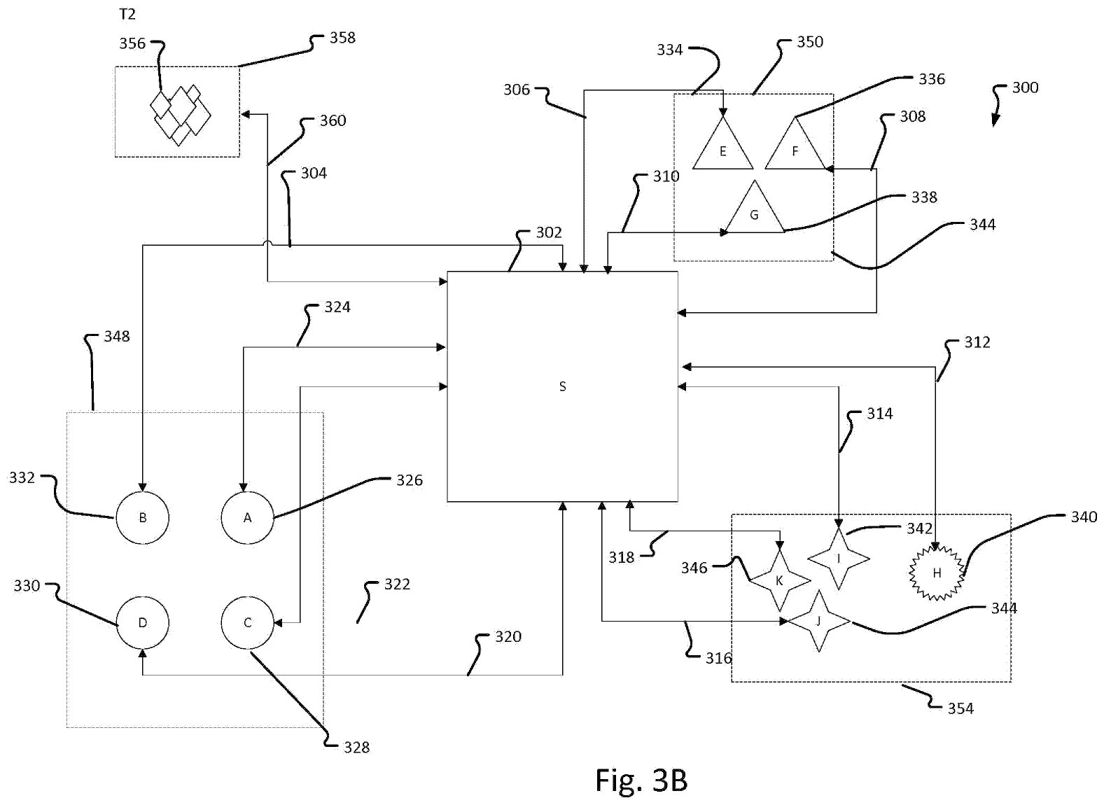

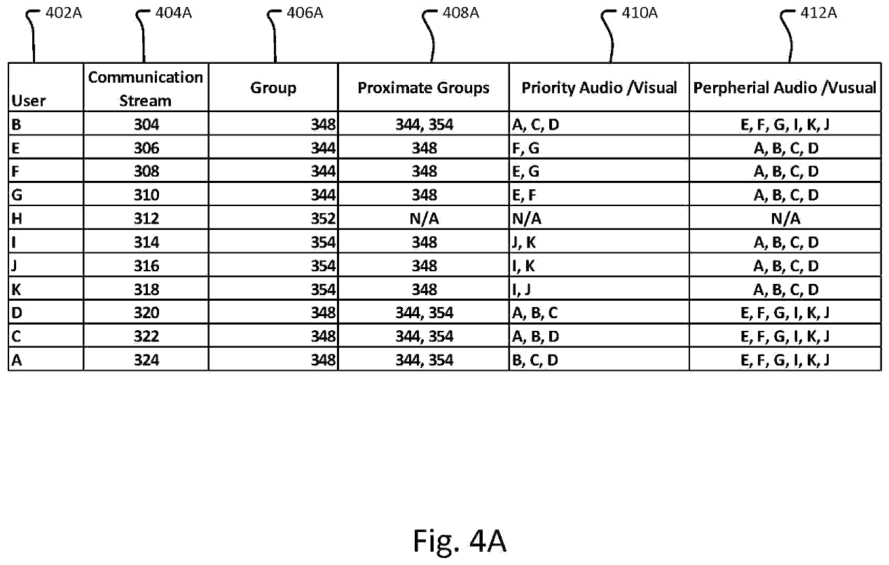

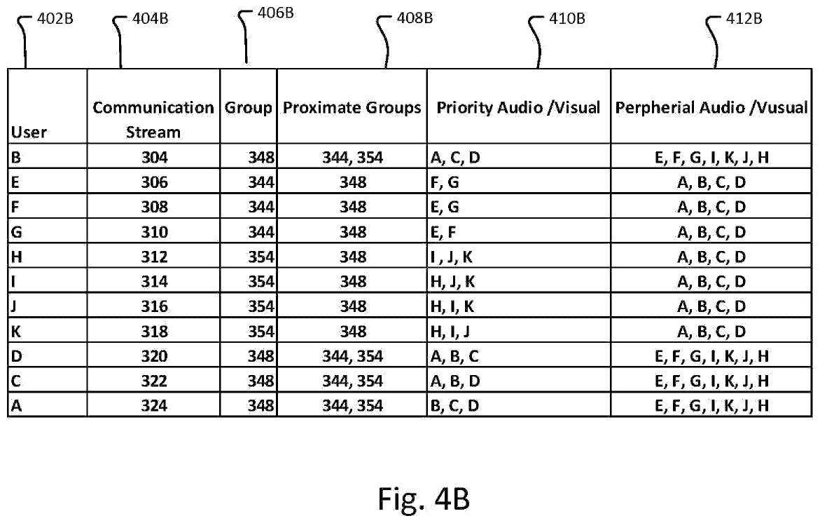

FIGS. 3A and 3B illustrate examples of handling a change in group assignment of users over time that may be employed using the technologies described herein. FIGS. 4A and 4B are tables that correspond to the examples described in FIGS. 3A and 3B. FIG. 3A illustrates five groups of users at a time, T1. These groups include a first group 348, a second group 350, a third group 352, a fourth group 354, and a plurality of other groups 358. It will be appreciated that more or less groups may be present during a virtual conference call without deviating from the scope of the innovative technologies described herein.

As illustrated in FIG. 3A, first group 348 includes user A 326, a user B 332, a user C 328, and a user D 330 at time T1. T1 corresponds to the table illustrated in FIGS. 4A and 4B. As shown in column three 406A labeled “group,” and column five 410A, each of the users within a group receive priority audio and video of the other users in the group. For example, an inspection of column one 402A and column five 410A illustrates user A having priority audio/video from B, C, and D, user B having priority audio/video of users A, C, and D, user C having priority audio/video of users A, B, and D, and user D having priority audio/video of users A, B, and C. Communication to each user is facilitated by the server 302 using the communication streams indicated by observing the column 402A and the communications stream indicated in column two 404A. For example, communications stream 304 is used to allow user B to communicate to server 302, which is also illustrated in FIGS. 3A and 3B.

Column four 408A indicates the groups which are associated as proximate to the group indicated in column three 406A. For example, user K is associated with first group 348 and is proximate to groups 344 and 354. Indeed, FIG. 4A illustrates that, user K will receive priority audio/video content from users I and J at time T1 and will receive peripheral audio/video content from users A, B, C, D.

As illustrated, T1 is a time in which a user H 340 has yet to be assigned a group. In the example provided, the user H 340 does not have any priority content from any user because user H 340 is not in a group. In other examples, a host or designated user is the automatic priority audio/video content for any new users. Also as illustrated, the user H has no peripheral audio/visual content from any users. In some examples, user H will be assigned peripheral groups as discussed above or may be assigned peripheral content by a predetermined list. Alternatively, the user may be prompted to select, through interaction with a GUI at a client application, one or more groups to add as peripheral before choosing a group to join. This will, in examples, allow the user to receive peripheral content from that group.

Additionally illustrated are a plurality of other groups 358 which may make up one or more users 356 in one or more groups. The plurality of other groups 358 is illustrated as not being designated as being peripheral to any of the first group 348, the second group 350, the third group 352, or the fourth group 354. Thus, it is contemplated that all groups may necessarily be successfully linked by peripheral groups, though in some examples, they are (e.g., in the linear scheme described above).

FIG. 3B illustrates an example state of a grouping during a virtual conference call at time T2. As illustrated user H 340 is now in the fourth group 354. In this example, user H 340 now receives priority audio/video content based on user H 340's association with fourth group 354. H 340 now receives priority audio/video content from users I, J, and K, as illustrated. Additionally, user H 340 also receives peripheral audio/video content from users A, B, C, and D because user H 340 is now a member of fourth group 354. As illustrated (though it need not be), any user who is a member of a group with fourth group 354 designated as proximate will now receive peripheral audio/video content from user H 340. In this example, that include users A, B, C, and D.

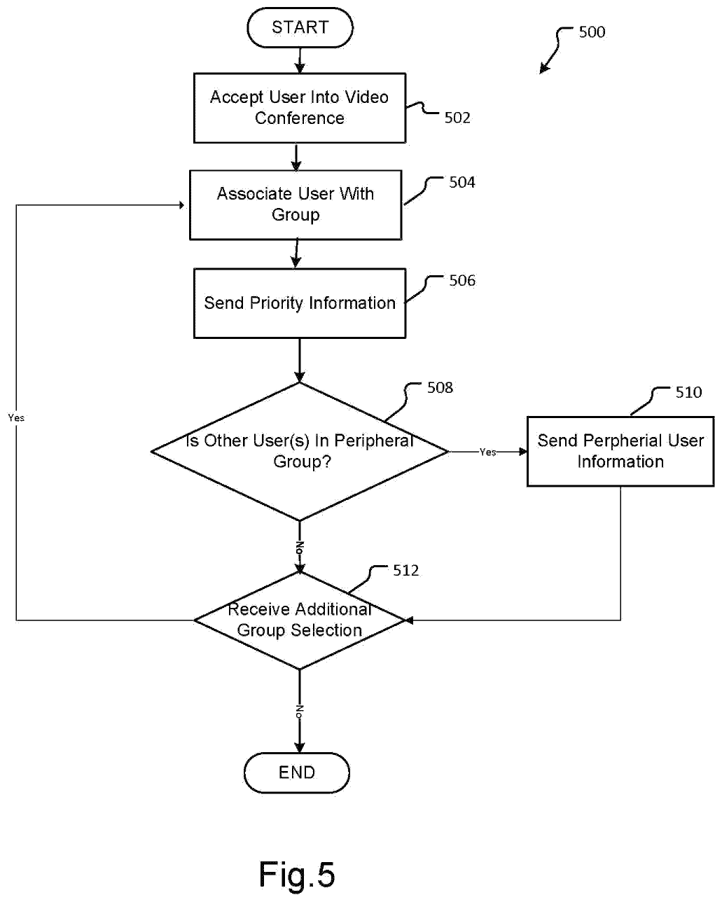

FIG. 5 is an example method 500 for assigning a user of a virtual call to a group. Method 500 begins with accept user into video conference operation 502. In operation 502, a client application, such as the client applications described above, connects with a server (e.g., the one or more servers described herein). In an example, an application from a participant computer sends a request to the server through a client application. The request contains, in examples, details such as the user's identity and the conference room the user wishes to join (as transmitted through the application, for example). A particular protocol may be used, such as WebRTC. The server then processes this request and establishes the appropriate connections sufficient to let the user in the conference room.

Method 500 then proceeds to associate user to a group operation 504. In operation 504, the user is associated with a group. As described further herein, a user's association with a group may be used to determine, at least in part, the prominence and/availability of audio/video of other members of the virtual call. For example, a conference call application may display ingroup users in the middle of the screen and at a louder volume than other members of the conference call. Assignment of a user to a group may occur by default. For example, a user may be assigned to a group with or by a conference participant who is the administrator. Alternatively, the user may enter the conference call as a group of 1 (only the particular user). The user may then, through interaction with a GUI, join another group. Alternatively, the AI engine may assign a user a group based on a natural language analysis of previous audio/chats used by the user in other conference calls (or other gathered data).

Method 500 then proceeds to send priority information operation 506. Priority information may be sent to those users in the same group as a particular user. In operation 506, the client application receives priority audio/video information. In an example, the priority audio/video information is sufficient for the application to display one or more other users of the conference more prominently than other users of the conference call and/or more loudly than other members of the conference call.

Method 500 then proceeds to determination 508, where it is determined whether other users are in a group associated as peripheral to the original user's group. In an example, a group may be associated with other groups as peripheral. This association may be preset by an administrator of the program, or the AI Engine may automatically update peripheral group information based on a natural language analysis of the communications occurring in each group (and the related nature of the conversation). In other aspects, a linear peripheral group scheme may be employed as described herein. If groups are identified as peripheral, and users are in those peripheral groups, then method 500 proceeds to send peripheral user information operation 510.

In operation 510, information sufficient for a user to display other users as peripheral are sent. This may include instructions to display audio/video of peripheral users (e.g., users that are in groups peripheral to a first user). For example, peripheral users may be displayed in smaller windows, without video content (e.g., displaying only photographs or avatar of users), and with a softer audio.

After operation 510, or if determination operation 508 is no, then the method 500 proceeds to receive additional group selection determination 512. If additional group selection is received (e.g., through a GUI at a participant device), then method 500 returns to associate user with group operation 504. If not, the method 500 ends.

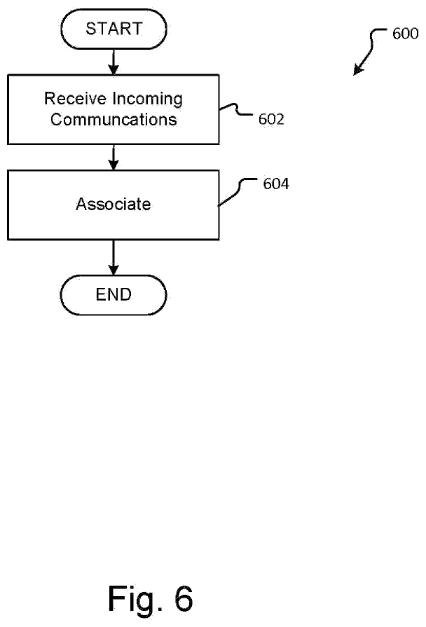

FIG. 6 is an example method 600 of organizing input communication streams for users of a virtual call. Method 600 begins with receive incoming communications stream from one or more users operation 602. In examples, communication streams (such as audio, video, and textual input captured by a participant computer) are encoded and transmitted to one or more servers.

Method 600 then proceeds to associate operation 604, where each of those incoming audio/video streams of a user is associated with a group. In examples, for each communication stream received from a user in a virtual conference call, the server may associate that stream with the user and/or with a group. Such association may occur by using one or more of relationships, keys, and references.

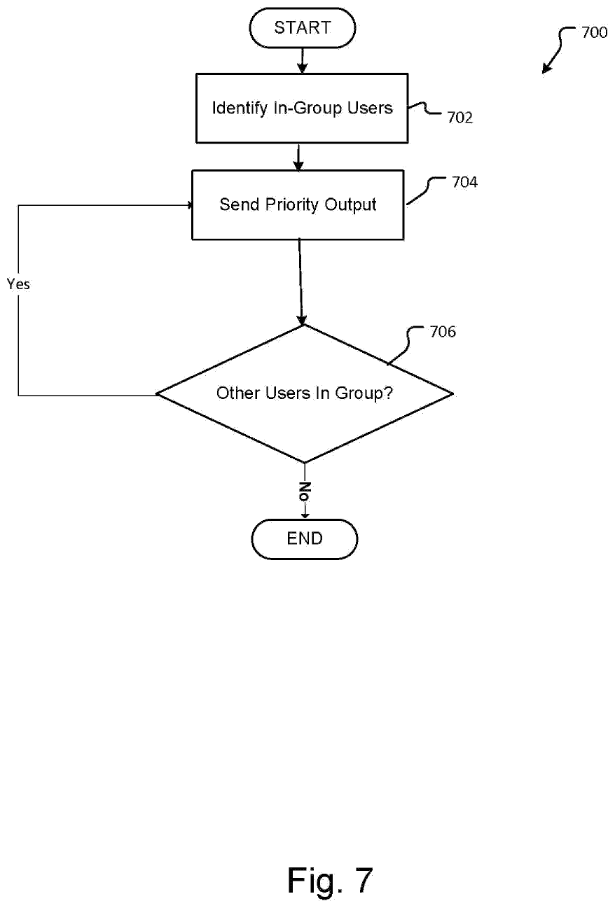

FIG. 7 is an example method 700 for determining priority content to deliver to a particular user of a group. Method 700 begins with identify ingroup user operation 702. In operation 702, other members who are in the same group as the particular user are identified, for example, by a server. It will be appreciated that “particular user” has no meaning other than to note that the particular user is different from other users. Other users in the group may be individually identified as well, and may be referred to as a second user, a third user, etc., (with no ordered meaning implied), a different user, another particular user, and the like. In aspects of the technology, one or more servers may identify each member who is in the same group as the particular user.

Method 700 then proceeds to send priority output operation 704. In operation 704, audio/video output of each other user in the group is sent to the particular user. Priority audio/video output may be output sufficient to cause the audio/video of the other members of the group to be displayed/broadcast more prominently than other users who are not in the group.

Method 700 then proceeds to determination 706. In determination 706, it is determined whether there are additional users in the group. If so, the next user is identified and method 700 then returns to operation 704, before which the additional identified user is set to the particular user. If not, the method ends.

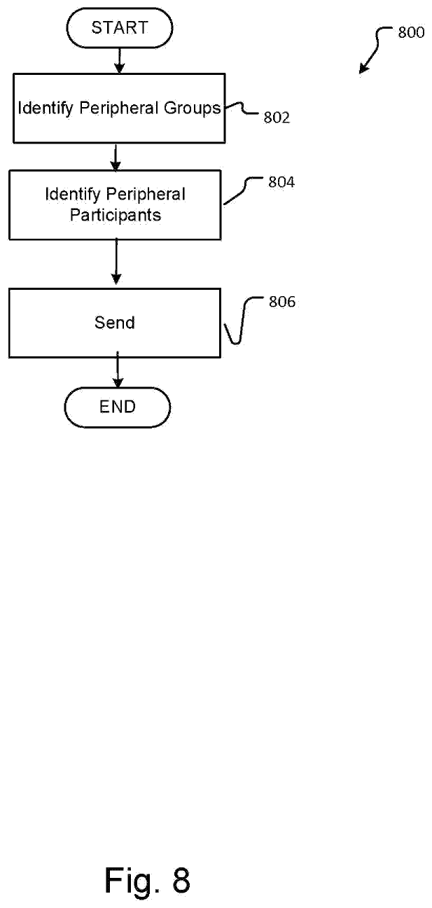

FIG. 8 is an example method 800 for determining peripheral content to deliver to users of a particular group. Method 800 begins with identify peripheral groups operation 802. In operation 802, one or more groups are identified as peripheral to the particular group. This may be identified by accessing a database storing data indicating which groups are associated as peripheral. It will be appreciated that particular group has no meaning other than to note that the particular group is different from other groups. Other groups in the virtual conference call may be individually identified as well, and may be referred to as a second group, a third group, etc., (with no ordered meaning implied), a different group, another particular group, and the like.

Method 800 then proceeds to identify peripheral call participants operation 804. In operation 804, participants who are members of the one or more peripheral groups identified in operation 802 are identified to form peripheral participants. This may occur by cataloging, tagging, or otherwise recording the current participants of the one or more peripheral groups.

Method 800 then proceeds to send operation 806. In operation 806, one or more servers sends each user of the particular group information sufficient to display peripheral content. This may be information sufficient for users of the particular group to display video (or images) and/or broadcast the audio of each of the peripheral participants. For example, one or more servers may have received input communication streams from each of the peripheral participants as described herein. The server may then use those input communication streams to send each user of the particular group peripheral content information of the peripheral participants. The method then ends.

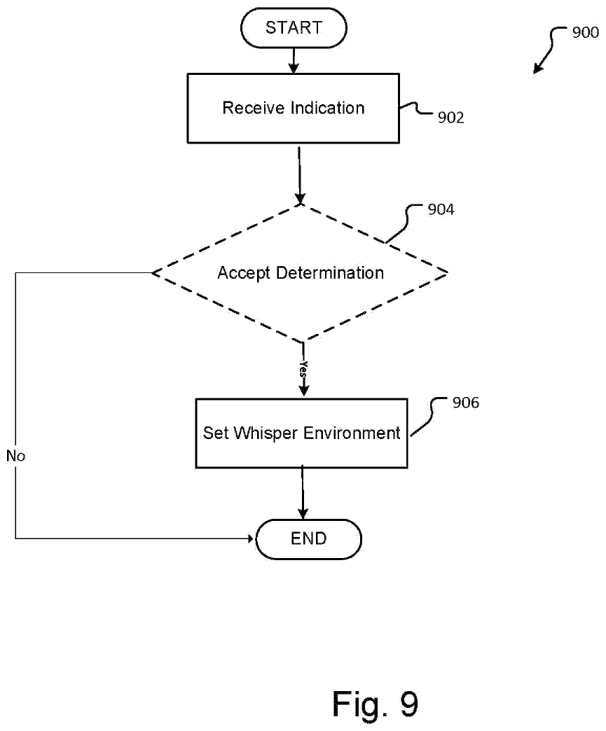

FIG. 9 is a method for sending a private message to another user of a virtual call. Method 900 begins with receive indication to send private user a message operation 902. This indication may be sent by a user (the whispering user) interacting with a client application on a participant computing device. For example, the whispering user may click on an image or video of another participant (the target participant) in the virtual conference call to indicate that the whispering user wishes to send a private message to the target user.

Method 900 then optionally proceeds to accept determination 904. In determination 904, communication may be sent to the target user's client application indicating that the whispering user wishes to send a message to the target user. In aspects of the technology, the target user's application may wait for an indication of acceptance from the target user. This may occur by, for example, the target user clicking accept or otherwise interacting with a GUI and/or the client application.

After receive indication 902, or in the event that the accept determination was accepted in determination 904, operation then proceeds to set whisper environment 906. In operation 906 a whisper environment is set. This may be set by the server sending control information to the application of the whispering user and the target user so that they can only hear each other. In examples, users who are in the peripheral and/or ingroup users may be sent an indication noting that the target user and the whispering user are in a private conversation. In an example, each in group user display an icon indicating that the target user and/or the whispering user are in a private conversation. In some aspects where video of the users is displayed, that video may cease to be delivered to other members of the group and or members of peripheral groups of the target user and/or whispering user. In examples, an image may be sent instead of a video. This may both prevent distraction and decrease network usage. The method then ends.

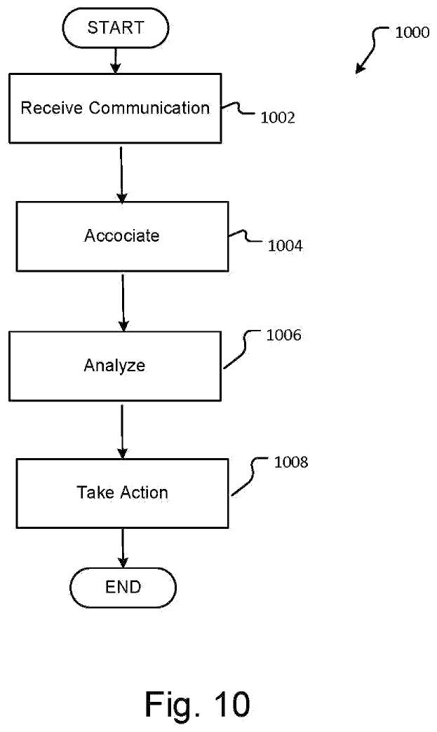

FIG. 10 is a method for analyzing a virtual call using artificial intelligence. Method 1000 begins with receive communication input operation 1002. In operation 1002, communications may be received from one or more users of a virtual call. Communications may be received as part of input communication streams, as further provided herein. In aspects, the communications are audio inputs from users, which may be converted to text or another recognizable form suitable for processing by an AI engine, such as the AI engine described herein. Additionally, chat from the virtual call may also be received.

Method 1000 then proceeds to associate operation 1004. In operation 1004, one or more users who generated the content (e.g., by talking in a virtual conference call or typing in chat) is associated with the content. Additionally, other information, such as group name, peripheral groups, and other ingroup users and peripheral users to the content generating user may be associated with each user, the group, and/or peripheral groups. This information forms at least a part of user content information.

Method 1000 then proceeds to analyze user content information operation 1006. In operation 1006, the content is analyzed to determine one or more topics of conversation in the various groups of a virtual conference call. For example, the DNN may identify the topic of conversation of a particular user and/or a particular group. In aspects of the technology, a Deep Neural Network (“DNN”) is used. For example, a DNN might be trained on large datasets of user content information, where each text is labeled with its corresponding one or more topics. As it learns, the network hones its ability to recognize patterns and structures in the text that indicate a particular topic for a user and/or group. When presented with new, unseen text, such as new user content information, the trained DNN then analyzes the language and outputs the most likely topic of conversation based on the patterns it has previously learned.

Method 1000 then proceeds to take action operation 1008. In operation 1008, an action may be taken based on topics identified in operation 1006. For example, a group in a virtual call may have a name indicating the topic. That name may be different from the topic identified in operation 1008. In such a case, the action may be to change the group name to the topic identified in operation 1008. Additionally/alternatively, the DNN may have identified that a user is discussing one topic, whereas the rest of the group is discussing another. In such a case, a prompt may be sent to the user to indicate other groups that are discussing the same topic as the user. After operation 1008, the method ends.

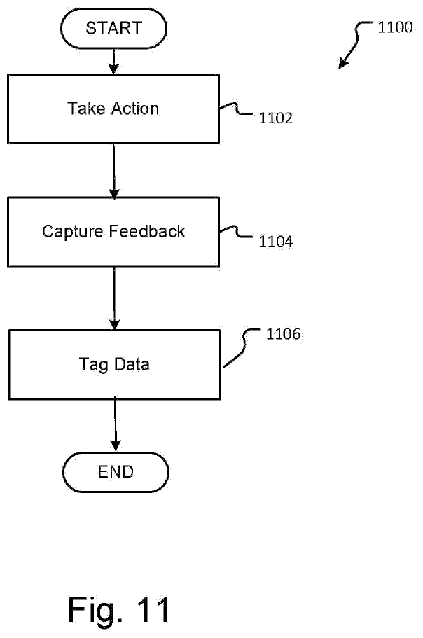

FIG. 11 is a method 1100 for training a DNN using feedback from a virtual call. The DNN may be the same as described above. Method 1100 begins with take action operation 1102. Take action operation 1102 may be the same or similar as the take action operation 1008 discussed above.

Method 1100 then proceeds to capture feedback operation 1104. For example, where the topic of a group was changed to match the identified topic, feedback may include a user manually changing the topic back to the previous or different topic. In some instances, not receiving a change for a certain period of time, such as 5 minutes, 10 minutes, etc. may also be observed. Additionally, where a different group was suggested to a user based on a user topic, it may be captured where the user changes group or does not for a set period of time.

Method 1100 then proceeds to tag data operation 1106. When the captured data indicates that the DNN performed adequately (e.g., when the user switches group or the group name is not changed within a certain period of time), the user content information and suggestion is sent to a DNN to update the model as tagged data.

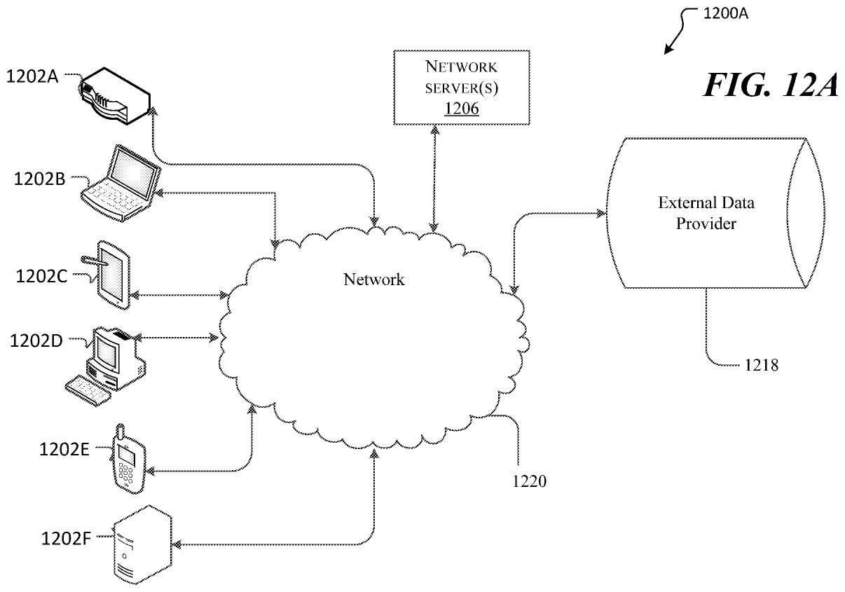

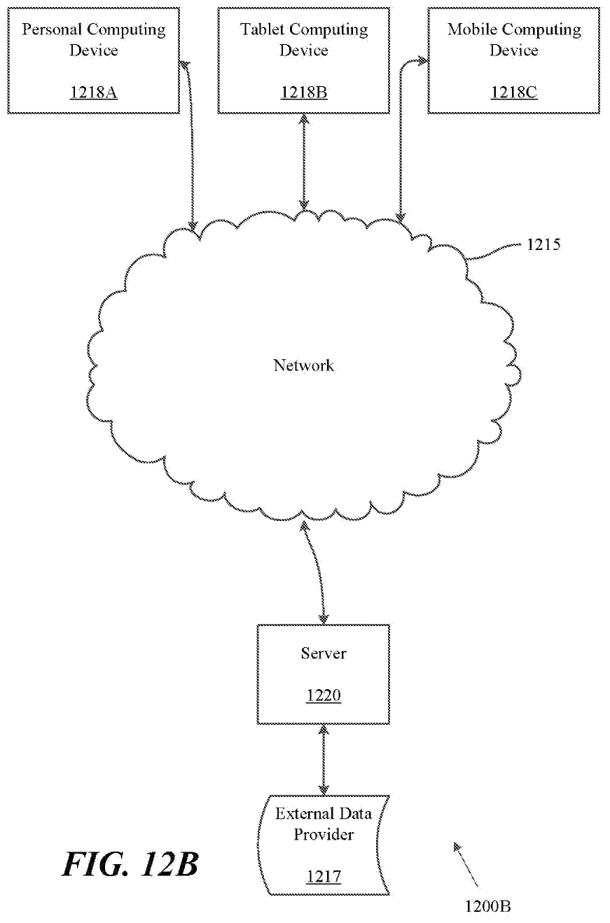

FIG. 12A is an example diagram of a distributed computing system 1200A in which aspects of the present innovative technology, including the virtual call environment described above, may be implemented. According to examples, any of computing devices, such as a modem 1202A, a laptop computer 1202B, a tablet 1202C, a personal computer 1202D, a smart phone 1202E, and a server 1202F, may contain engines, components, etc. for instantiating the virtual call environment described above. Additionally, according to aspects discussed herein, any of the computing devices described or referred to herein may contain necessary hardware for implementing aspects of the disclosure. Any and/or all of these functions may be performed, by way of example, a network of servers and/or one server when computing devices request or receive data from external data provider by way of a network 1220.

Turning to FIG. 12B, one embodiment of the architecture of a system for performing the technology discussed herein is presented. Virtual call environments interacted with, requested, and/or edited in association with one or more computing devices may be stored in different communication channels or other storage types. For example, data may be stored using a directory service, a web portal, a mailbox service, an instant messaging store, or a compiled networking service for facilitating a virtual call environment as described herein. The distributed computing system 1200B may be used for running the various engines to instantiate the virtual call environment, such as the engines described with reference to FIG. 2 above. The computing devices 1218A, 1218B, and/or 1218C may provide a request to a cloud/network 1215, which is then processed by a network server 1220 in communication with an external data provider 1217. By way of example, a participant computing device may be implemented as any of the systems described herein and embodied in the personal computing device 1218A, the tablet computing device 1218B, and/or the mobile computing device 1218C (e.g., a smart phone). Any of these aspects of the systems described herein may obtain content from the external data provider 1217.

In various examples, the types of networks used for communication between the computing devices that make up the present invention include, but are not limited to, an Internet, an intranet, wide area networks (WAN), local area networks (LAN), virtual private networks (VPN), GPS devices, SONAR devices, cellular networks, and additional satellite based data providers such as the Iridium satellite constellation which provides voice and data coverage to satellite phones, pagers, and integrated transceivers, etc. According to aspects of the present disclosure, the networks may include an enterprise network and a network through which a client computing device may access an enterprise network. According to additional aspects, a client network is a separate network accessing an enterprise network through externally available entry points, such as a gateway, a remote access protocol, or a public or private Internet address.

Additionally, the logical operations may be implemented as algorithms in software, firmware, analog/digital circuitry, and/or any combination thereof, without deviating from the scope of the present disclosure. The software, firmware, or similar sequence of computer instructions may be encoded and stored upon a computer readable storage medium. The software, firmware, or similar sequence of computer instructions may also be encoded within a carrier-wave signal for transmission between computing devices.

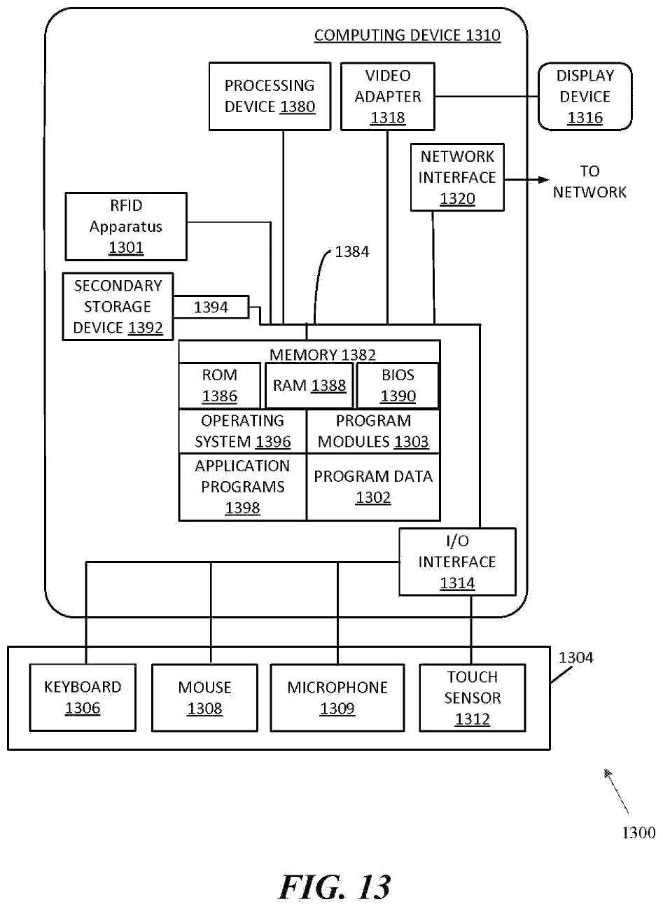

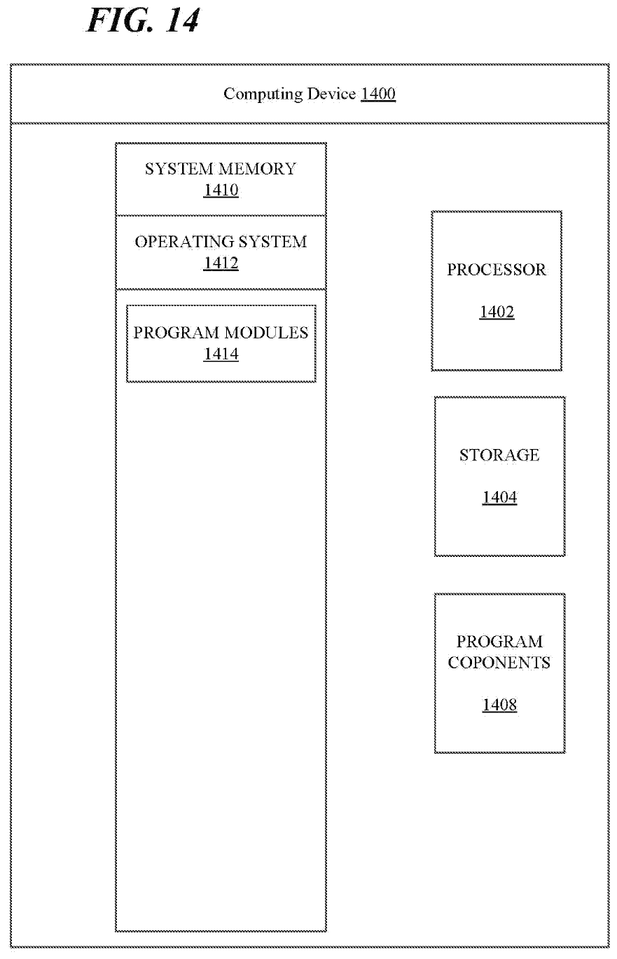

Operating environment 1300 typically includes at least some form of computer-readable media. Computer-readable media can be any available media that can be accessed by a processor such as processing device 1380 depicted in FIG. 13 and processor 1402 shown in FIG. 14 or other devices comprising the operating environment 1300. By way of example, and not limitation, computer-readable media may comprise computer storage media and communication media. Computer storage media includes volatile and nonvolatile, removable and non-removable media implemented in any method or technology for storage of information such as computer-readable instructions, data structures, program engines or other data. Computer storage media includes, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which can be used to store the desired information. Computer storage media does not include communication media.

Communication media embodies computer readable instructions, data structures, program engines, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer-readable media.

The operating environment 1300 may be a single computer operating in a networked environment using logical connections to one or more remote computers. The remote computer may be a personal computer, a GPS device, a monitoring device such as a static-monitoring device or a mobile monitoring device, a pod, a mobile deployment device, a server, a router, a network PC, a peer device or other common network node, and typically includes many or all of the elements described above as well as others not so mentioned. The logical connections may include any method supported by available communications media. Such networking environments are commonplace in enterprise-wide computer networks, intranets and the Internet.

FIG. 14 illustrates one aspect of a computing device 1400, which may be used to implement aspects of the present disclosure, including any of the plurality of computing devices described herein with reference to the various figures and their corresponding descriptions. The computing device 1400 illustrated in FIG. 14 can be used to execute an operating system 1396, application programs 1398, and program modules 1303 (including the engines described with reference to FIG. 2) described herein.

The computing device 1310 includes, in some embodiments, at least one processing device 1380, such as a central processing unit (CPU). A variety of processing devices are available from a variety of manufacturers, for example, Intel, Advanced Micro Devices, and/or ARM microprocessors. In this example, the computing device 1310 also includes a system memory 1382, and a system bus 1384 that couples various system components including the system memory 1382 to the at least one processing device 1380. The system bus 1384 is one of any number of types of bus structures including a memory bus, or memory controller; a peripheral bus; and a local bus using any of a variety of bus architectures.

Examples of devices suitable for the computing device 1310 include a server computer, a pod, a mobile-monitoring device, a mobile deployment device, a static-monitoring device, a desktop computer, a laptop computer, a tablet computer, a mobile computing device (such as a smart phone, an iPod® or iPad® mobile digital device, or other mobile devices), or other devices configured to process digital instructions.

Although the exemplary environment described herein employs a hard disk drive as a secondary storage device, other types of computer readable storage media are used in other aspects according to the disclosure. Examples of these other types of computer readable storage media include magnetic cassettes, flash memory cards, digital video disks, Bernoulli cartridges, compact disc read only memories, digital versatile disk read only memories, random access memories, or read only memories. Additional aspects may include non-transitory media. Additionally, such computer readable storage media can include local storage or cloud-based storage.

A number of program engines can be stored in the secondary storage device 1392 or the memory 1382, including an operating system 1396, one or more application programs 1398, other program modules 1303 (such as the software engines described herein), and program data 1302. The computing device 1310 can utilize any suitable operating system, such as Linux, Microsoft Windows™, Google Chrome™, Apple OS, and any other operating system suitable for a computing device.

According to examples, a user provides inputs to the computing device 1310 through one or more input devices 1304. Examples of input devices 1304 include a keyboard 1306, a mouse 1308, a microphone 1309, and a touch sensor 1312 (such as a touchpad or touch sensitive display). Additional examples may include input devices other than those specified by the keyboard 1306, the mouse 1308, the microphone 1309 and the touch sensor 1312. The input devices are often connected to the processing device 1380 through an input/output (I/O) interface 1314 that is coupled to the system bus 1384. These input devices 1304 can be connected by any number of I/O interfaces 1314, such as a parallel port, serial port, game port, or a universal serial bus. Wireless communication between input devices 1304 and the interface 1314 is possible as well, and includes infrared, BLUETOOTH® wireless technology, cellular and other radio frequency communication systems in some possible aspects.

In an exemplary aspect, a display device 1316, such as a monitor, liquid crystal display device, projector, or touch-sensitive display device, is also connected to the computing system 1300 via an interface, such as a video adapter 1318. In addition to the display device 1316, the computing device can include various other peripheral devices, such as speakers or a printer.

When used in a local area networking environment or a wide area networking environment (such as the Internet), the computing device 1310 is typically connected to a network such as network 1220 shown in FIGS. 12A and 12B through a network interface, such as an Ethernet interface. Other possible embodiments use other communication devices. For example, certain aspects of the computing device 1310 may include a modem for communicating across the network. The computing device 1310 typically includes at least some form of computer-readable media. Computer-readable media includes any available media that can be accessed by the computing device 1310. By way of example, computer-readable media include computer-readable storage media and computer-readable communication media.

The computing device 1310 illustrated in FIG. 13 is also an example of programmable electronics, which may include one or more such computing devices, and when multiple computing devices are included, such computing devices can be coupled together with a suitable data communication network so as to collectively perform the various functions, methods, or operations disclosed herein.

FIG. 14 is a block diagram illustrating additional physical components (e.g., hardware) of a computing device 1400 with which certain aspects of the disclosure may be practiced. Computing device 1400 may perform these functions alone or in combination with a distributed computing network such as those described with regard to FIGS. 12A and 12B which may be in operative contact with personal computing device 1218A, tablet computing device 1218B and/or mobile computing device 1218C which may communicate and process one or more of the program engines described herein.

In a basic configuration, the computing device 1400 may include at least one processor 1402 and a system memory 1410. Depending on the configuration and type of computing device, the system memory 1410 may comprise, but is not limited to, volatile storage (e.g., random access memory), non-volatile storage (e.g., read-only memory), flash memory, or any combination of such memories. The system memory 1410 may include an operating system 1412 and one or more program modules 1414. The operating system 1412, for example, may be suitable for controlling the operation of the computing device 1400. Furthermore, aspects of the disclosure may be practiced in conjunction with a graphics library, other operating systems, or any other application program and are not limited to any particular application or system.

The computing device 1400 may have additional features or functionality. For example, the computing device 1400 may also include additional data storage device (removable and/or non-removable) such as, for example, magnetic disks, optical disks, or tape. Such additional storage is illustrated in FIG. 14 by storage 1404. It will be well understood by those of skill in the art that storage may also occur via the distributed computing networks described in FIG. 12A and FIG. 12B. For example, computing device 1400 may communicate via network 1220 in FIG. 12A and data may be stored within network servers 1206 and transmitted back to computing device 1400 via network 1220 if it is determined that such stored data is necessary to execute one or more functions described herein. Additionally, computing device 1400 may communicate via network 1220 in and data may be stored within network server 1206 and transmitted back to computing devices 1202A-1202F via network 1220 if it is determined that such stored data is necessary to execute one or more functions described herein.

As stated above, a number of program engines and data files may be stored in the system memory 1410. While executing the at least one processor 1402, the program modules 1414 may perform processes including, but not limited to, the aspects described herein.

One skilled in the art will appreciate the foregoing detailed description is provided by way of illustration and not limitation. The examples presented herein are intended to facilitate a clear understanding of the innovative technologies disclosed, and they are not exhaustive of the potential embodiments or examples encompassed by the scope of this disclosure. Those skilled in the art will readily recognize alternative implementations and variations that remain within the broad principles of the invention. Therefore, it should be understood that the scope of the present disclosure encompasses all such modifications and alternative embodiments as fall within the true spirit and scope of the appended claims.

What is claimed:

1. A computer-implemented method comprising:
receiving a plurality of requests to join a virtual meeting;
allowing access to the virtual meeting to at least a first user, a second user, a third user, and a fourth user based in part on in part the plurality of requests;
grouping the first user's audio input and the second user's audio input into a first audio input cluster;
grouping the third user's audio input and the fourth user's audio input into a second audio input group; and
altering a first-user audio output to the first user such that the first audio group is louder than the second audio input group.

2. The computer-implemented method of claim 1, further comprising:
outputting instructions to the first user to display a visual representation of a second user more prominently than a visual representation of the third user or a visual representation of a fourth user.

3. The computer-implemented method of claim 1, further comprising:
receiving, from a whispering user, a request to private message a target user of a virtual conference call;
sending a request to accept the private message to a client application associated with the target user;
receiving an indication of acceptance; and
based on receiving the indication of acceptance, setting a whispering environment to facilitate a private voice conversation between the target user and the whispering user.

4. The computer-implemented method of claim 3, wherein setting the whispering environment comprises alerting other members a group associated with the target user that the target user is in a private conversation.

5. The computer-implemented method of claim 4, wherein alerting includes changing a video image of the target user to a still image.

6. The computer-implemented method of claim 1, further comprising:
associating a first users input with the first user;
analyzing, using a Deep Neural Network, the first users input to determine a first user's topic of conversation; and
suggesting a different group to the first user based on the determination.

7. The computer-implemented method of claim 6, further comprising:
receiving an indication that the first user wishes to change groups based on the suggesting operation.

8. A computer-implemented method comprising:
receiving, from a server, a request from a plurality of clients to join a virtual conference call, wherein the plurality of clients includes a first client having a first input communication stream including audio and video data captured by the first client and a second client having a second input communication stream including audio and video data captured by the second client;
sending at least a portion of the audio and video data captured by the first client and at least a portion of the audio and video data captured by the second client to at least a portion of the other of the plurality of clients;
receiving a request from the first client to send a private whisper to the second client;
and, based on the request, setting a whisper environment.

9. The computer-implemented method of claim 8, wherein setting the whisper environment comprises:
reducing an amount of data of the audio and video data captured by the first client that is sent to the at least a portion of the other of the plurality of clients; and
reducing an amount of data of the audio and video data captured by the second client that is sent to the at least a portion of the other of the plurality of clients.

10. The computer-implemented method of claim 8, further comprising:
sending an indication to the at least a portion of a plurality of other clients that the first client and the second client are in a whisper environment.

11. The computer implemented method of claim 9, wherein the indication is selected from the group consisting of: a graphical indication, changing a video feed of the first client and the second client to a still image, and an audio indication.

12. The computer-implemented method of claim 8, further comprising, before setting the whisper environment, sending an approval request to the second client and receiving, from the second client, an approval.

13. A computer-readable storage device having instructions that, when executed by at least one processor, performs a method, the method comprising:
receiving a plurality of requests to join a virtual meeting;
allowing access to the virtual meeting to at least a first user, a second user, a third user, and a fourth user based in part on in part the plurality of requests;
grouping the first user's audio input and the second user's audio input into a first audio input cluster;
grouping the third user's audio input and the fourth user's audio input into a second audio input group; and
altering a first-user audio output to the first user such that the first audio group is louder than the second audio input group.

14. The computer-readable storage device of claim 13, wherein the method further comprises:
outputting instructions to the first user to display a visual representation of a second user more prominently than a visual representation of the third user or a visual representation of a fourth user.

15. The computer-readable storage device of claim 13, wherein the method further comprises:
receiving, from a whispering user, a request to private message a target user of a virtual conference call;
sending a request to accept the private message to a client application associated with the target user;
receiving an indication of acceptance; and
based on receiving the indication of acceptance, setting a whispering environment to facilitate a private voice conversation between the target user and the whispering user.

16. The computer-readable storage device of claim 15, wherein setting the whispering environment comprises alerting other members a group associated with the target user that the target user is in a private conversation.

17. The computer-readable storage device of claim 16, wherein alerting includes changing a video image of the target user to a still image.

18. The computer-readable storage device of claim 13, the method further comprising:
associating a first user's input with the first user;
analyzing, using a Deep Neural Network, the first user's input to determine a first user's topic of conversation; and
suggesting a different group to the first user based on the determination.

19. The computer-readable storage device of claim 18, the method further comprising:
receiving an indication that the first user wishes to change groups based on the suggesting operation.

20. The computer-readable storage device of claim 15, wherein sending a request to accept the private message occurs of via use of an intranet.
